(19) United States
(12) Patent Application Publication
(10) Pub. No.: US 2002/0112015 A1
(43) Pub. Date: Aug. 15, 2002

(54) Selective security encryption of electronic communication for selected recipients

(75) Inventor: Thomas Richard Haynes, Apex, NC (US)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY (US)

(21) Appl. No.: 10/116,019

(22) Filed: Apr. 3, 2002

Related U.S. Application Data
(63) Continuation-in-part of application No. 09/260,934, filed on Mar. 2, 1999.

(51) Int. Cl. G06F 15/16

(52) U.S. Cl. 709/206

(57) ABSTRACT

A method for distinguishing recipients of electronic communication on a data processing data processing system utilizing the recipient's electronic addresses. Electronic communication is first addressed to at least two recipients with corresponding recipient addresses. The security of the communication is enhanced by enabling the sender to encrypt the communication of selected recipients from among a larger number of recipients being sent the communication simultaneously. The selected recipients e-mail address are tagged and when the sender selects the transmit (or send) option on the e-mail GUI, the communication for those tagged addresses are first encrypted (via an encryption engine) before being transmitted to the recipients. The recipient may also be sent an encryption key to decrypt the communication. Otherwise, the encryption key may be a private key associated with the particular recipients address and stored on the recipient's system. The communication is therefore transmitted in encrypted form but decrypted once it arrives at the recipient's system.

### RELATED APPLICATIONS

The present invention is a Continuation-In-Part of commonly owned and assigned, co-pending patent application Ser. No. 09/260,934 (Attorney Docket No. RP9-99-001), filed on Mar. 2, 1999. Applicant hereby claims priority from the above filing date of Mar. 2, 1999. The claims of the current application are directed to canceled claim 29, which was subject to a restriction in the Application from which priority is claimed.

### BACKGROUND OF THE INVENTION

1. Technical Field

The present invention relates in general to electronic communications via data processing systems, and in particular to a method and system for enhancing security in electronic communication sent to particular recipients. Still more particularly, the present invention relates to a method and system for enhancing security in electronic communications issued by a user of a data processing system, whereby a sender of an outgoing electronic communication selects particular recipients, whose communication is encrypted before transmission.

2. Description of the Related Art

Electronic document transfer and message communication such as electronic mail (e-mail), are well known in the art. With the fast evolving global electronic network following the opening up of world-wide communication channels such as the Internet or World Wide Web, transmission of data and non-data communication via electronic means on a data processing system network is becoming more and more common.

E-mail communication makes up a significant and fast growing portion of the communication environment which exists on the Internet. More and more users globally are communicating via e-mail, which is considerably cheaper than regular telephone network or other related communication systems. Similarly, file and document transfer via file transfer protocol (FTP) is becoming increasingly popular.

Users of the Internet are provided with a user address which serves as an electronic mail box. A user is able to create an electronic communication and transmit it to one or more other users via their respective user address. Messages are thus capable of being simultaneously transmitted to a plurality of recipients. This is usually accomplished when the sender (or originator) of the communication enters the respective address of each desired recipient in the “addressing” location of the software being utilized to transmit the document.

FIG. 1 depicts a prior art representation of a graphical user interface (GUI) 101 of Lotus Notes program (Lotus Notes is a Trademark of International Business Machines, Inc. (IBM), assignee of the present invention). Lotus Notes GUI 101 consists of pull down menu buttons 103A, tool bars 103B, and a visual display area 105. Within visual display area 105, is depicted a electronic communication comprising of an addressing area (“To”, “cc”, “bcc”, and “subject”) 107, a security selection area 108 and a level of importance selection area 109. Below the visual display area 105 is the message area 111 where the text of the message is typed.

In today's electronic mail environments, when a user creates a note to be sent to one or more recipients, the user is usually given an option to select the communication as belonging to a certain level of “importance”. For instance, Lotus Notes offers three choices: “Urgent” 110A, “Normal” 110B, and “FYI” 110C. The assignment selected is applied to all recipients of the note, regardless of classification (“To”, “cc”, or “bcc”).

A note sender might very well want to assign different importance levels to different recipients. For instance, one might want a note to be of “Urgent” importance to one set of recipients, but “Normal” to others and “FYI” to yet another subset.

Likewise, the sender may wish to provide different levels of security to the contents of the message being transmitted. Selection of the security option (e.g.,“IBM confidential”), however, merely informs the recipient that the sender considers the message to be confidential. The message is however still readable to anyone with access to the received message or who may intercept the message, particularly if the message is transmitted outside the company's firewall (i.e., to an external recipient).

Currently, to assign different levels of importance to subgroups of recipients, the sender must send out the same document more than once—each time, to the recipients identified for the importance level desired. For example, the sender sends a note first to Sam and Mary at importance “Urgent”, then sends the same note out to Joe and Jill at importance “Normal”. There is no simple way of doing this today.

Likewise, to provide security to a message being transmitted, the content must first be locked or encrypted. The ability to lock a document is available with most word processing software currently available. A password is provided (or created), and the sender may then transmit the locked document to recipient and provide the recipient with the password to unlock the document once transmitted.

Some applications allow a document to be encrypted and provided with an encryption key. In both methods (i.e., locking and encrypting the document), the document has to be locked/encrypted within the specific application that provides the specific function, attached to the e-mail, and sent to all of the recipients to whom the communication is addressed. Every recipient thus receives the locked or encrypted document. Oftentimes, however, not every recipient communication requires the enhanced security measures. For example, the sender may be behind a firewall and wish to transmit a single message to recipients inside and outside of the firewall. Those recipients inside the firewall do not need special security measures with their communication, while those outside the firewall do. Presently, the only way to transmit the same message to these two groups of recipients is to transmit two separate messages: a first message to recipients within the firewall; and a second encrypted message to recipients outside the firewall. As described above, transmitting the second message entails encrypting (or locking) the message with another application, attaching the message to an e-mail, and then transmitting the encrypted message to those recipients outside the firewall. Notably, present e-mail engines require the encrypted message to be transmitted as an attached document as there is no option within the e-mail engine for encryption or locking of the message when typed directly into the message area.

The present invention recognizes that it would therefore be desirable to have a method and system for selectively assigning security levels for each recipient of an electronic document that enables particular recipients to received a coded/encrypted copy of a message that is transmitted to other recipients in a regular manner. A method and system by which a communication engine with associated background encryption software enables automatic encryption of copies of a message being communicated to a plurality of selected recipients would be a welcomed invention. These and other benefits are provided by the invention described herein.

### SUMMARY OF THE INVENTION

A method is disclosed for distinguishing recipients of electronic communication on a data processing system utilizing the recipient's electronic address. Electronic communication is first addressed to at least two recipients with corresponding recipient addresses. Then specific characteristics, from among a plurality of characteristics, are linked to one or more of the recipient addresses, wherein the characteristic serves to distinguish the recipient's communication from the communication of other recipients.

In the illustrative embodiment, implemented in an e-mail environment, linking the characteristics is completed by first selecting one or more recipient e-mail addresses, then choosing the characteristic desired to be linked to the e-mail communication of each selected recipient. The chosen characteristic is linked with the e-mail communication being sent via the recipient's address. When the communication is sent, the recipient receives his communication with the characteristics applied to it.

According to the claims and the preferred embodiment, the security of the communication is enhanced by enabling the sender to encrypt the communication of selected recipients from among a larger number of recipients being sent the communication simultaneously. The selected recipients' e-mail addresses are tagged and, when the sender selects the transmit (or send) option on the e-mail GUI, the communication for those tagged addresses are first encrypted (via an encryption engine) before being transmitted to the selected recipients. In one embodiment the recipient is also sent an encryption key in a separate, follow-on e-mail to decrypt the communication. In another embodiment, the encryption key is a private key associated with the particular recipient's address and stored on the recipient's system. The communication is therefore transmitted in encrypted form, but decrypted once it arrives at the recipient's system.

The above, as well as additional objects, features, and advantages of the present invention will become apparent in the detailed written description.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a prior art diagram of a Lotus Notes™ graphical user interface;

FIG. 2 is a diagram of a data processing system utilized in the preferred embodiment of the present invention;

FIG. 3 is a block diagram of a electronic communication environment GUI in accordance with one embodiment of the present invention;

FIG. 4A is a logic flow chart of the process involved in one general embodiment of the present invention;

FIG. 4B is a block diagram illustrating the component parts of a computer system involved in the encryption of a message prior to its transmission in accordance with one implementation of the present invention; and

FIG. 5 is a logic flow chart of the process of encrypting a message being transmitted to selected recipients from among multiple recipients of a communication in accordance with one embodiment of the invention.

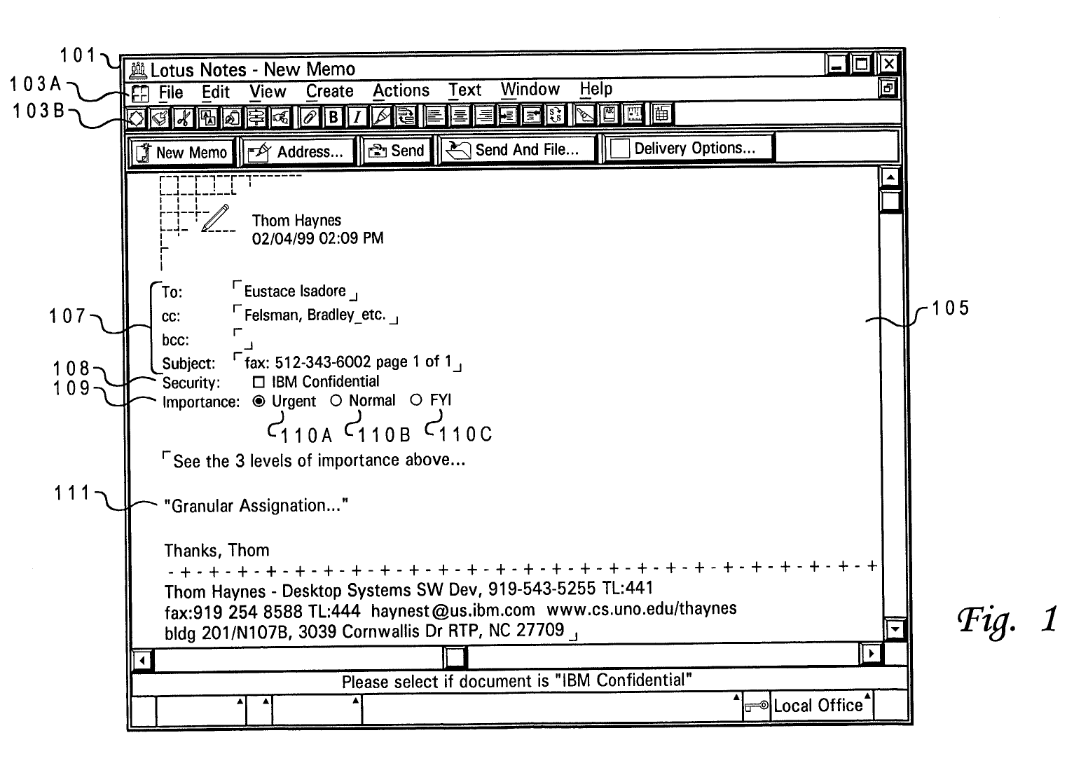

### DETAILED DESCRIPTION OF AN ILLUSTRATIVE EMBODIMENT

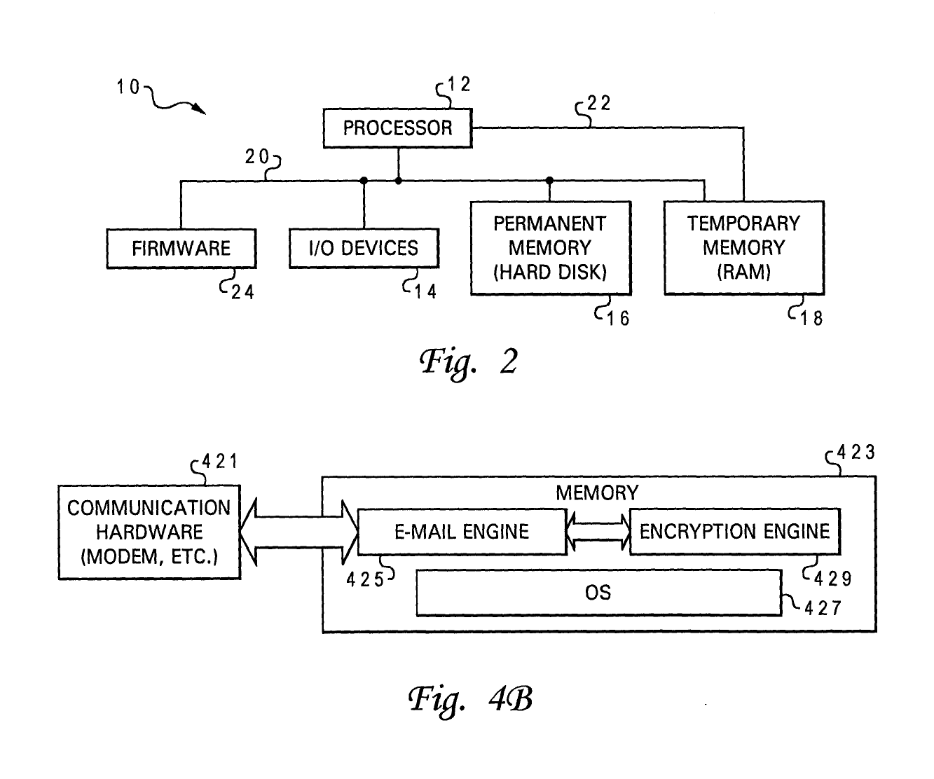

With reference now to the figures, and in particular with reference to FIG. 2, there is depicted the basic structure of a data processing system 10 utilized in the preferred embodiment of the invention. Data processing system 10 has at least one central processing unit (CPU) or processor 12 which is connected to several peripheral devices, including input/output devices 14 (such as a display monitor, keyboard, and graphical pointing device) for user interface, a permanent memory device 16 (such as a hard disk) for storing the data processing system's operating system and user programs/applications, and a temporary memory device 18 (such as random access memory or RAM) that is utilized by processor 12 to implement program instructions. Processor 12 communicates with the peripheral devices by various means, including a bus 20 or a direct channel 22 (more than one bus may be provided utilizing a bus bridge).

Data processing system 10 may have many additional components which are not shown such as serial, parallel, and universal serial bus (USB) ports for connection to, e.g., modems or printers. In the preferred embodiment of the invention, communication to and from the data processing system is made possible via a modem connected to a land line (telephone system) which is in turn connected to a network provider such as an Internet service provider (ISP). Additionally or alternatively, data processing system may be connected to a local area network (LAN) via an ethernet/network card. Communicated data is transmitted via and arrives at the modem or network card and is processed to be received by the data processing system's CPU or other software application.

Those skilled in the art will further appreciate that there are other components that might be utilized in conjunction with those shown in the block diagram of FIG. 2. For example, a display adapter connected to processor 12 might be utilized to control a video display monitor, and a memory controller may be utilized as an interface between temporary memory device 18 and processor 12. Data processing system 10 also includes firmware 24 whose primary purpose is to seek out and load an operating system from one of the peripherals (usually permanent memory device 16) whenever the data processing system 10 is first turned on. In the preferred embodiment, data processing system 10 contains a relatively fast CPU 12 along with sufficient temporary memory device 18 and space on permanent memory device 16, and other required hardware components necessary for providing hardware support to electronic communication capabilities.

Conventional data processing systems often employ a graphical user interface (GUI) to present information to the user. The GUI is created by software that is loaded on the data processing system, specifically, the data processing system's operating system acting in conjunction with application programs. Two well-known GUIs include OS/2 (a trademark of International Business Machines Corp.) and Windows (a trademark of Microsoft Corp.), which can be utilized with the present invention.

This invention implements a method and system for individually assigning security to a communication being transmitted, where selected ones of a plurality of recipients of the electronic communication are sent their communication in encrypted format. For the purposes of this invention, electronic communications include (by way of example and without limitation) e-mail messages, files transmitted via file transfer protocol (FTP), Internet/web pages, chat or newsgroup communications, and terminal emulation. Those skilled in the art recognize that this list may include other forms of electronic communication similar to those listed above. Also, although the invention is described with particular reference to encryption of messages, other types of security measures (e.g., locking the file with a password) may be utilized within the implementation of the invention.

The implementation of the present invention occurs on the data processing system described above, loaded with a software application containing a program algorithm which permits individual selection of addresses and individual assignments of security levels for electronic communications.

In the illustrative embodiment of the invention, implemented in an e-mail environment, the data processing system is equipped with an e-mail engine, such as Eudora by Qualcomm, Inc. The engine is the resident software for creating, receiving, displaying and manipulating e-mail messages. It provides options to create and address new mail messages. The messages are transmitted via an outgoing server utilizing a transfer protocol, such as Simple Mail Transfer Protocol (SMTP). Those skilled in the art are familiar with the workings of an e-mail engine. In the illustrative embodiment, the data processing system is also equipped with an encryption engine.

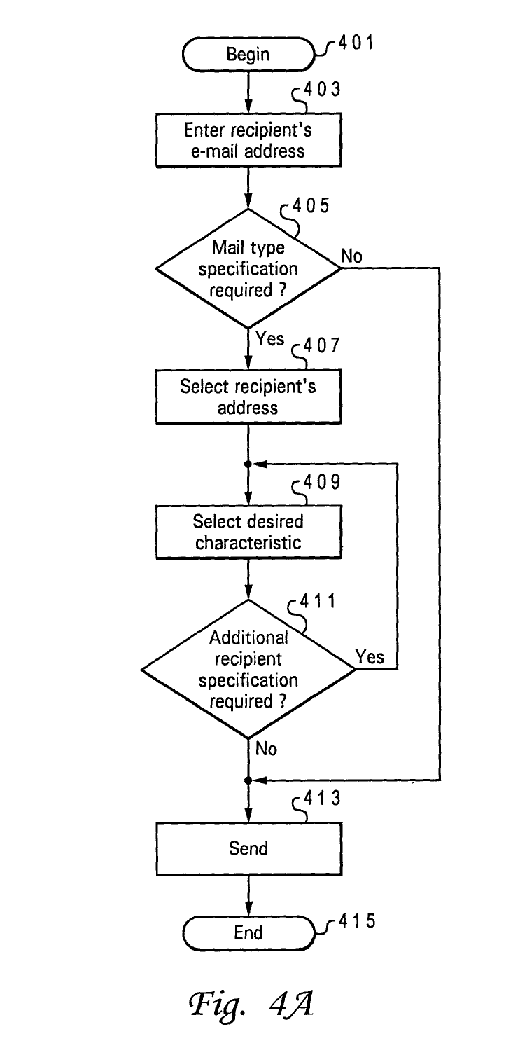

FIG. 4B illustrates sample components of the data processing system, which may advantageously be utilized to implement the features of the invention. Depicted is memory 423, in which the operating system (OS) 427 and application software code is stored. Software application codes includes code for implementing e-mail engine 425 and encryption engine 429. Thus, the data processing system is loaded with encryption software which is directly accessible by the e-mail engine 425. E-mail engine communicates with the outside network via communication hardware 421, such as modems, network cards, etc. Any type of encryption engine may be utilized to effect the message encryption steps described herein. In one embodiment, the encryption engine 429 is a sub-component of e-mail engine 425, and is packaged with the e-mail engine 425.

An e-mail message is routed to a Post Office Protocol (POP) server on which the mail is stored until accessed by the recipient. When the recipient logs into his mail account utilizing an e-mail engine, and connects to the POP server, the incoming e-mail messages are downloaded into the recipient's data processing system into the e-mail engine's In-box. In the illustrative embodiment, the recipient receives a tag which indicates the security level assigned to the e-mail by the sender. In a more generalized embodiment, the e-mail message is displayed or marked with particular characteristics selected by the sender of the message.

For the purposes of the invention, a recipient is described as anyone whom a sender of an electronic communication selects to receive the electronic communication. Further, the recipient is represented by a corresponding recipient address. Those skilled in the art understand the allocation of electronic addresses to users within an electronic communication environment. For the purpose of the invention, the term recipient and recipient address shall be understood to refer to the recipient and utilized interchangeably. During implementation of the invention, the changes made to the communication of a particular recipient are linked to the recipient via the recipient's address. This change or selection of characteristics to apply to the recipient address affects the way the communication is sent to that particular recipient or what occurs to the communication sent to that recipient. For example, a recipient's communication may be tagged/marked “encrypted” while in the recipient's In-box if the recipient's address was selected for encrypted communication by the sender. In another embodiment, a recipient's communication may be password protected as a result of the sender selecting that characteristic to link to the recipient's address. For simplicity, all forms of encryption, encoding, password protection, etc., will be generally referred to as a security option, and the invention is described with specific application of the encryption feature.

During implementation of the illustrative embodiment of the invention, the sender may select one characteristic from among a plurality of characteristics to assign to one or more specified recipients of the communication via the recipients' addresses. In a first implementation, the sender may select a global choice which is applied to every recipient address. The sender may also select any particular one recipient address and modify the respective choice for each. For example, the communication may be automatically labeled as un-coded/un-encrypted for every recipient address. The sender then selects particular recipients via their respective address and assigns those selected recipients a “decrypted” classification.

In one possible implementation utilizing a data processing system with a pointing device (e.g., a mouse), the sender selects with the pointing device (usually a mouse) in the “To”, “cc”, or “bcc” field, the address of the recipient whose security level would differ from the global choice. This causes the recipient address to be highlighted and permits the sender to select a different classification/characteristic to apply.

Alternatively, the sender could select multiple recipients by any of a variety of common GUI techniques, as those skilled in the art will recognize, such as marquee selection, or mouse clicks in conjunction with augmentation keys (e.g., shift and control). The chosen classification then applies to all selected recipients.

In yet another embodiment of the invention, a less granular way to provide security level capability allows the sender to assign different levels of importance based not on individual recipients, but rather on the type of recipient field. In this embodiment, for instance, the sender indicates that every recipient in the “cc” list should be marked “encrypted”. Additionally, this characteristic may be assigned at a group level when mail address groups are utilized. In this embodiment, a particular group represents a particular characteristic and placing a recipient's e-mail address in that group results in that characteristic being automatically applied to the e-mail address.

In one implementation, a separate addressing area is provided in addition to the standard To, cc, and bcc designations. For example, “sTo” or “secure To” is provided for entry of those addresses for which the communication is desired to be encrypted. Notably, this configuration works well for e-mailers who communicate sensitive information to individuals both inside and outside a firewall, as occurs when teams are created between two or more corporations to work together on a particular product. Actual positioning of the sTo area within the e-mail GUI is not required for a correct understanding of the invention.

In one preferred embodiment, utilizing standard operations of a mouse connected to a data processing system, clicking right-button causes a context (pop-up) menu to appear. The selections in the menu comprise of a cascading menu item called importance, with a plurality of choices including for example, “Urgent”, and “FYI” (other levels of importance may be defined if desired). The menu items may also comprise menu items for security, with at least a single selectable choice “encode” (or encrypt). The sender may choose a different value than the global choice. This selected value is then applied and those selected recipients would have that different value of importance.

For e-mail engines utilized primarily for secure transmissions, the e-mail engine may provide an automatic background encryption process for all addresses it recognizes as existing outside of the firewall. In a related embodiment, the e-mail engine may allow for storage of recipient addresses that are identified by the sender as requiring encrypted communication at all times.

In the illustrative embodiment, indication (feedback) of this different characteristic of a particular recipient communication would be presented to the sender. This feedback may be completed in one of a number of ways including font manipulation (bold, italics, etc.) and color-coded representation. In font manipulation, each font represents a particular characteristic and similarly in color-coded representation. Thus, for example, communication for recipients receiving an encrypted communication may be bolded.

In one embodiment, when the sender sends the document, and it is received in the In-box of a recipient, the list of addresses do not indicate to the recipient that there were any modifications from the global choice (that is, for example, all textual addresses for all addressees would be the same color or font).

In the illustrative embodiment, once the sender attaches characteristics to a particular recipient's address, the address is displayed within the e-mail GUI with a color code as described above. In an illustrative color coded scheme, for example, messages marked “encrypted” may be displayed in red. It is understood by those skilled in the art that although only three levels are presented in this illustration, any number of levels or variations in characteristics may be utilized in the preferred embodiment. A software developer may provide a complex array of choices from which the sender may choose. Further, this array may include additional options not specifically related to levels of importance.

In another embodiment of the invention, distribution lists are handled similarly. The e-mail system is enhanced to allow the sender to work with the individual addresses that comprised the distribution list. The sender may then select particular addresses and link those addresses to particular characteristics. The distribution list is then stored with the characteristics linked to the corresponding addresses.

In one embodiment, a stored copy of an address is created with the security characteristic associated. The security characteristic operates as a default state, whereby every access to the address is automatically provided with said security characteristic enabled. After selection of the address, however, the sender may choose to disable the security characteristic of the address for that particular communication. Disabling the security characteristic may be accomplished by left-clicking the mouse and un-checking that option. This embodiment finds applicability with selected recipients, whose communication the sender knows will typically require encryption.

In one illustrative embodiment in which e-mail communication is received by the user on an e-mail engine, a series of steps necessary to implement the invention are disclosed. The e-mail engine is created by a software resident on the data processing system. The e-mail engine typically consists of GUIs which provide a display area and a number of options for user interface.

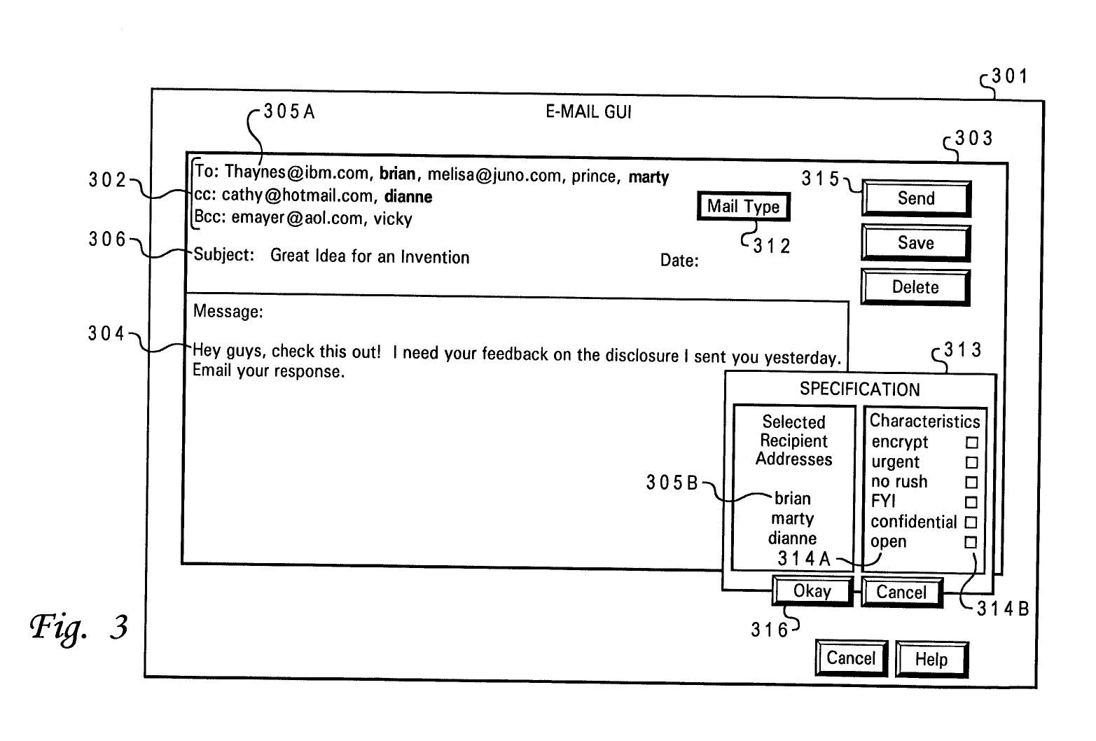

FIG. 3 depicts an e-mail GUI 301 according to the preferred embodiment and shows how the invention may be implemented. Specifically, it depicts how the interface is augmented to include an individual priority assignment option. E-mail GUI 301 contains typical items for user interface including, a display area 303 divided into two sections, an address section 302 and a message section 304. Address section 302 contains the list of recipient addresses 305A in one of a three categories “To:”, “cc:”, and “bcc:”. Recipient addresses 305A are manually entered or selected from an address book by the sender of e-mail messages and may contain one or more than one address. In the current illustration, at least two addresses are entered in this section. A subject option 306 is also present below address section 302. E-mail GUI 301 also has mail option buttons 315 to determine what step to take with a created communication.

In this embodiment, e-mail GUI 301 is provided with a “mail type” button 312 which is selectable by the sender. Selection of mail type button 312 opens up a “specification” GUI 313 which contains a list of any selected recipient addresses 305B and a series of possible characteristics 314A which a sender may apply to the communication to those recipients by clicking on the corresponding check boxes 314B. In this embodiment, if no recipient address 305A is preselected, characteristic 314A selected is applied to the entire group of recipients. Selection of check boxes 314B automatically links the corresponding characteristic 314A with pre-selected recipient addresses 305B. The sender closes Specification GUI 313 and applies the characteristics by selecting okay button 316.

In another embodiment of the present invention, a user selects a list of e-mail addresses utilizing a mouse and clicks on the left button to bring up the Specification GUI 313. It is understood by those skilled in the art that variations exist in the embodiments of the present invention but that all these variations fall within the scope of the present invention.

In yet another embodiment of the present invention, a user may apply a particular characteristic to a particular recipient's e-mail address. In this embodiment, the characteristic applies to all future communications to that recipient by default without the sender having to select the characteristic each time. Visible application of the characteristic to the recipient's address whenever the address is selected informs the user that the default settings may need to be changed.

FIG. 4A depicts a flow chart of the process which occurs in a data processing system during the implementation of the invention in an e-mail environment. The process begins (step 401) when a sender decides to send a communication and enters the address(es) of the desired recipients (step 403). A first determination is made as to whether or not the sender desires to set security characteristics to recipients of the communication (step 405). If the sender does not wish to set particular characteristics, then the communication is sent to the recipients (step 413) unencrypted. If, however, the sender desires to set particular security level for a recipient's communication, then the sender highlights the recipient's address (step 409) and selects coded/encryption option (step 411).

The process of selecting a recipient address and applying a particular characteristics continues until the sender is completed with the selections and sends the e-mail (step 413). The e-mail is sent to the encryption engine, and the communication is encrypted for those recipients selected by the sender. The process then ends (step 415). It is understood that although the selection process described herein is completed one address at a time, the invention contemplates being implemented by simultaneous selection of multiple addresses.

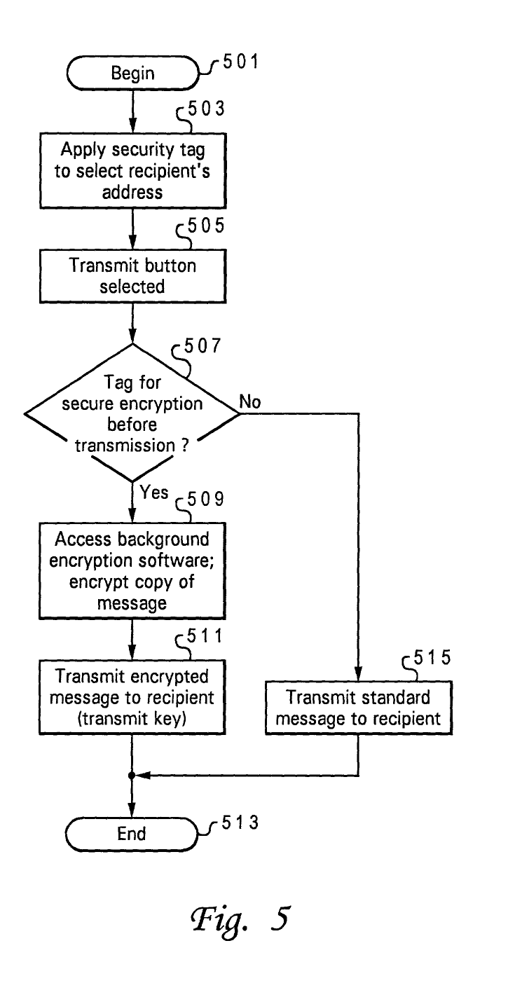

FIG. 5 is a flow chart of the process by which communication to specific recipients are encrypted. The process begins (step 501) when a sender selects a recipient address and applies a security tag/designation to the selected recipient address (step 503). The sender then selects the transmit button (step 505), which activates the background security mechanisms. For each address present in the address areas of the e-mail system, a determination is made (step 507) whether the address is tagged for security/encryption. If the address is not tagged for security/encryption, the communication is transmitted as a standard text message to the recipient (step 515). However, if the address has been tagged for security/encryption, a copy of the communication is sent to the encryption engine (step 509), and the communication is encrypted for those recipients selected by the sender. The encrypted communication is then sent to the particular recipients (step 511) and the process ends (step 513). As with FIG. 4A, although the encryption process described herein is completed one address at a time, the invention preferably completes a single encryption step and the encrypted copy of the communication is then distributed to each recipient designated to receive an encrypted copy.

One extension of the invention applies directly to the implementation described in the parent application, the entire content of which has been incorporated by reference. Accordingly, the invention provides security encryption based on the message importance selected for the particular recipient. Thus, in the case where the writer/sender of an e-mail utilizes the techniques of the invention to specify different levels of importance for different recipients of the same communication, the invention employs different security measures in the transmission based on those choices. For example, all recipients marked “Normal” may receive a flat-text version of the e-mail, whereas all recipients designated as “Urgent” may receive a disguised (encrypted) version. Of course this illustration assumes that messages that are marked urgent are necessarily of greater importance. This implementation is also orthogonal to whether or not the communication is being transmitted through a firewall.

While the invention has been particularly shown and described with reference to an illustrative embodiment, it will be understood by those skilled in the art that various changes in form and detail may be made therein without departing from the spirit and scope of the invention. For example, different types of characteristics besides the security level of the communication may be desired to be linked to a particular communication. For example, identifying the urgency of the communication, may be provided as an option to the sender. The invention is also applicable to other types of mail systems besides the standard computer based e-mail engines. For example, current mail systems that operate on a PDA, cell phone or via voice mail may implement the features described herein.

As a final matter, it is important that while an illustrative embodiment of the present invention has been, and will continue to be, described in the context of a fully functional data processing system, those skilled in the art will appreciate that the software aspects of an illustrative embodiment of the present invention are capable of being distributed as a program product in a variety of forms, and that an illustrative embodiment of the present invention applies equally regardless of the particular type of signal bearing medium used to actually carry out the distribution. Examples of signal bearing media include recordable media such as floppy disks, hard disk drives, CD-ROMs, and transmission media such as digital and analog communication links.

Although the invention has been described with reference to specific embodiments, this description should not be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method for preparing an electronic communication on a data processing system addressed to one or more recipients, each with a corresponding electronic address, said method comprising the steps of:
addressing said electronic communication to one or more recipients via respective electronic addresses; and
associating a specific security characteristic to a selected electronic address from among said respective electronic addresses, wherein said specific security characteristic distinguishes an encryption format for a copy of said electronic communication to be transmitted to said selected electronic address such that said encryption format is automatically applied to said copy of said communication when transmitted.

2. The method of claim 1, further comprising:
responsive to a selection of a send option for transmission of said electronic communication, automatically encrypting said copy of said electronic communication, such that said copy exhibits said security characteristic independent of other characteristics exhibited by other copies of said communication transmitted to other recipient addresses.

3. The method of claim 2, further comprising:
transmitting said copy of said electronic communication to said selected electronic address in encrypted format that is displayed within a received communication at a recipient's end of the transmission.

4. The method of claim 3, wherein said associating step further comprises:
first selecting one or more electronic address from said respective electronic addresses; and
choosing said security characteristic from among a plurality of characteristics to be exhibited within said copy of said electronic communication transmitted to said selected electronic address.

5. The method of claim 3, wherein said associating step further includes the step of indicating on a display device of said data processing system a selected security characteristic of said selected electronic address.

6. The method of claim 5, wherein said indicating step further includes the step of manipulating a font of said respective electronic addresses to correspond to said characteristic applied to said electronic addresses, wherein a predetermined font is provided with each characteristic of said plurality of characteristics, and further wherein said selected electronic address is displayed in the font associated with said security characteristic.

7. The method of claim 5, wherein said indicating step further includes the step of color coding said respective electronic addresses, wherein a color code is provided with said plurality of characteristics, whereby each color represents a particular characteristic from among said plurality of characteristics and further wherein said selected electronic address is displayed in the color associated with said security characteristic.

8. The method of claim 4, wherein said choosing step enables assigning different characteristics to different electronic addresses and said selected security characteristic to multiple selected electronic addresses.

9. The method of claim 8, wherein said assigning step is implemented within a distribution list of electronic addresses and wherein said characteristics of said electronic addresses within said distribution list are storable along with their respective electronic address.

10. The method of claim 3, further comprising:
associating particular security characteristics with particular addresses; and
storing said particular addresses along with other addresses within a distribution list prior to preparation of said communication for transmission.

11. The method of claim 3, further comprising automatically associating said security characteristic to a first address field, such that a communication associated with each address entered into said first address field exhibits said security characteristic independent of a communication associated with addresses entered into a second address field.

12. The method of claim 3, further comprising:
determining which addresses from among a plurality of addresses are outside of an internal firewall associated with said sender; and
automatically tagging said addresses for encryption prior to transmission of a communication to said addresses.

13. The method of claim 3, further comprising:
creating a stored copy of an address with said security characteristic associated, wherein every access to said address is automatically provided with said security characteristic enabled.

14. The method of claim 13, further comprising:
disabling said security characteristic of said address for a particular communication following selection of said stored copy of said address by selecting a disabling option provided.

15. The method of claim 3, wherein said electronic communication is an e-mail message.

16. A computer program product comprising:
a compute readable medium;
program instructions on said medium for enabling a user to prepare an electronic communication on a data processing system addressed to one or more recipients, each with a corresponding electronic address, said program instructions comprising instructions for:
addressing said electronic communication to one or more recipients via respective electronic addresses; and
associating a specific security characteristic to a selected electronic address from among said respective electronic addresses, wherein said specific security characteristic distinguishes an encryption format for a copy of said electronic communication to be transmitted to said selected electronic address such that said encryption format is automatically applied to said copy of said communication when transmitted.

17. The computer program product of claim 16, further comprising instructions for:
responsive to a selection of a send option for transmission of said electronic communication, automatically encrypting said copy of said electronic communication, such that said copy exhibits said security characteristic independent of other characteristics exhibited by other copies of said communication transmitted to other recipient addresses.

18. The computer program product of claim 17, further comprising instructions for:
transmitting said copy of said electronic communication to said selected electronic address in encrypted format that is displayed within a received communication at a recipient's end of the transmission.

19. The computer program product of claim 18, wherein said instructions for associating further comprises instructions for said user to:
first select one or more electronic address from said respective electronic addresses; and
choose said security characteristic from among a plurality of characteristics to be exhibited within said copy of said electronic communication transmitted to said selected electronic address.

20. The computer program product of claim 18, wherein said instructions for associating further includes instructions for indicating on a display device of said data processing system a selected security characteristic of said selected electronic address.

21. The computer program product of claim 20, wherein said instructions for indicating further includes instructions for manipulating a font of said respective electronic addresses to correspond to said characteristic applied to said electronic addresses, wherein a predetermined font is provided with each characteristic of said plurality of characteristics, and further wherein said selected electronic address is displayed in the font associated with said security characteristic.

22. The computer program product of claim 20, wherein said instructions for indicating further includes instructions for color coding said respective electronic addresses, wherein a color code is provided with said plurality of characteristics, whereby each color represents a particular characteristic from among said plurality of characteristics and further wherein said selected electronic address is displayed in the color associated with said security characteristic.

23. The computer program product of claim 19, wherein said instructions for choosing enables assigning different characteristics to different electronic addresses and said selected security characteristic to multiple selected electronic addresses.

24. The computer program product of claim 23, wherein said instructions for assigning, assigns said different characteristics within a distribution list of electronic addresses and wherein said characteristics of said electronic addresses within said distribution list are storable along with their respective electronic address.

25. The computer program product of claim 18, further comprising instructions for:
associating particular security characteristics with particular addresses; and
storing said particular addresses along with other addresses within a distribution list prior to preparation of said communication for transmission.

26. The computer program product of claim 18, further comprising instructions for automatically associating said security characteristic to a first address field, such that a communication associated with each address entered into said first address field exhibits said security characteristic independent of a communication associated with addresses entered into a second address field.

27. The computer program product of claim 18, further comprising instructions for:
determining which addresses from among a plurality of addresses are outside of an internal firewall associated with said sender; and
automatically tagging said addresses for encryption prior to transmission of a communication to said addresses.

28. The computer program product of claim 18, further comprising instructions for:
creating a stored copy of an address with said security characteristic associated, wherein every access to said address is automatically provided with said security characteristic enabled; and

29. The computer program product of claim 28, further comprising instructions for:
disabling said security characteristic of said address for a particular communication following selection of said stored copy of said address by selecting a disabling option provided.

30. The computer program product of claim 18, wherein said electronic communication is an e-mail message.

31. A data processing system comprising:
a processor and memory; and
program means for enabling a user to prepare an electronic communication on a data processing system addressed to one or more recipients, each with a corresponding electronic address, said program means comprising:
means for addressing said electronic communication to one or more recipients via respective electronic addresses; and
means for associating a specific security characteristic to a selected electronic address from among said respective electronic addresses, wherein said specific security characteristic distinguishes an encryption format for a copy of said electronic communication to be transmitted to said selected electronic address such that said encryption format is automatically applied to said copy of said communication when transmitted.

32. The data processing system of claim 31, further comprising:
means, responsive to a selection of a send option for transmission of said electronic communication, for automatically encrypting said copy of said electronic communication, such that said copy exhibits said security characteristic independent of other characteristics exhibited by other copies of said communication transmitted to other recipient addresses.

33. The data processing system of claim 32, further comprising:
means for transmitting said copy of said electronic communication to said selected electronic address in encrypted format that is displayed within a received communication at a recipient's end of the transmission.

34. A method for distinguishing an electronic communication on a data processing data processing system addressed to one or more recipients with a corresponding electronic address, said method comprising the steps of:
addressing said electronic communication to one or more recipients to create a plurality of recipients' addresses; and
linking a specific characteristic to a selected electronic address associated with one of said plurality of recipients, wherein said specific characteristic distinguishes a content of a copy of said communication transmitted to said selected electronic address and is automatically transmitted within said copy of said communication, which exhibits said characteristic independent of other characteristics exhibited by other copies of said communication transmitted to other recipient addresses;
wherein further said characteristics includes an encoding option, and, responsive to a selection of said encoding option with said selected recipient address, said method further includes transmitting said copy of said communication in encoded format to said recipient address, wherein said communication is transmitted un-coded to all other recipients for which said encoding option is not selected.
